(19) United States
(12) Patent Application Publication
(10) Pub. No.: US 2009/0020572 A1
(43) Pub. Date: Jan. 22, 2009

(54) Method for the Surface Treatment of Roof Racks for Motor Vehicles and Roof Racks for Motor Vehicles

(75) Inventors: Hans Binder, Bohmenkirch (DE); Ottmar Binder, Bohmenkirch (DE)

Correspondence Address: HARNESS, DICKEY & PIERCE, P.L.C., P.O. BOX 828, BLOOMFIELD HILLS, MI, 48303, US

(73) Assignee: HANS UND OTTMAR BINDER GMBH OBERFLACHENVEREDELUNG, Boehmenkirch (DE)

(21) Appl. No.: 12/223,680

(22) PCT Filed: Feb. 3, 2007
(86) PCT No.: PCT/EP2007/000932

§ 371 Date: Aug. 6, 2008

(30) Foreign Application Priority Data
Feb. 7, 2006 (DE) 10 2006 005 541.1

(51) Int. Cl. B60R 9/04; B44C 1/22; B24B 1/00

(52) U.S. Cl. 224/309; 216/52; 216/41; 451/57

(57) ABSTRACT

The invention relates to method for the surface treatment of roof racks for motor vehicles, the roof racks being composed of aluminum and/or aluminum alloy. Provision is made whereby the surface is polished at least in certain areas to achieve a brilliant finish, and the polished surface is abraded at least in certain areas to achieve a satin-finish surface section. In addition, the invention relates to a corresponding roof rack.

The invention relates to a method for the surface treatment of roof racks for motor vehicles and the like, the roof racks being composed of aluminum and/or aluminum alloy.

Roof racks for motor vehicles are composed of aluminum or aluminum alloys. They are finished by blast-cleaning, brushing, and/or etching their surface so as to obtain a “stainless-steel effect.” After the shaping process (for example, extrusion, bending, etc.), the surface of the completed roof rack in the form of a semi-finished product is treated such that it has a matt appearance. An alternative approach is known whereby after the shaping process (semi-finished product) the roof rack is polished to give the surface a brilliant finish. Depending on what is desired, roof luggage racks are available either with a brilliant surface or matt surface.

The fundamental problem to be solved by the invention is to provide a method for the surface treatment of roof luggage carriers that results in a special visual effect.

This problem is solved according to the invention by an approach whereby the surface is first polished at least in certain areas so as to achieve a brilliant finish, and the polished surface is then abraded at least in certain areas to achieve a satin-finish surface section. In contrast to the prior art, what is accordingly first implemented is a treatment of the surface to give it a brilliant finish, in other words a brilliant metallic finish. The brilliant finish can be achieved by a wide variety of polishing methods. Subsequently, the polished surface is again abraded at least in certain areas to obtain a satin-finish effect. The fact that certain areas remain with the brilliant finish while other area have a satin finish results in an especially effective appearance. The satin-finish-textured surface also has a special effect, a property that can be attributed to the fact that it was first polished and then produced by abrasion. This satin-finish effect produced according to the invention has a special visual effect that is not comparable with previous conventional methods, specifically, giving a matt appearance to a not-yet-treated surface by abrasion techniques. In particular, the use of the two surface treatments implemented according to the invention on the same component in a multistage-operation process results in a special visual effect, preferably, when both brilliant as well as satin-finish surface sections are present, in particular, adjacent to each other, on the same component.

It is advantageous to implement the abrasion on a spot basis. The brilliantly-polished surface is thus not abraded over its entire surface, but instead only in small zones, on a spot basis, for example, thereby achieving a special satin-finish effect.

It is advantageous to implement the abrasion by blast-cleaning, etching, and/or brushing. In terms of blast-cleaning, sand-blasting can be employed, for example.

In a development of the invention, at least one template is used whereby surface areas covered with the template retain the brilliant finish, while other surface areas are not covered and abraded as a result of the given surface treatment. The covering template thus protects areas from being abraded. Abrasion occurs in those areas where the template exposes the polished surface of the roof rack. This results in sharp-edged transitions that are set off between brilliant-finish areas and matt areas, and that create a special three-dimensional effect and bring about a high brilliancy which is not found on a normal surface receiving a single-stage treatment based on the prior art. The invention is distinguished precisely by the two-stage treatment—specifically, first generating the brilliant finish that is then converted at least in certain areas by abrasion to create a matt/satin effect.

In particular, provision is made whereby after polishing and abrading a now brilliant-finish and/or satin-finish surface section is anodized. The visual effect of the brilliant-finish surface sections and satin-finish surface sections is not destroyed by the subsequent anodizing process, but instead is surprisingly at least retained, if not even improved.

In addition, the invention relates to a roof rack, in particular, roof moldings, composed of aluminum and/or aluminum alloy having a surface that has a brilliant finish at least in certain areas as a result of polishing, and that has a satin finish at least in certain areas as a result of abrasion implemented after the polishing.

In order to produce the roof rack according to the invention, the rack is first fabricated as a semi-finished product, specifically produced by a shaping process, such as, for example, extrusion, bending, etc. The rack is composed of aluminum and/or aluminum alloy. Subsequently, the at least later-visible areas are polished to a brilliant finish, that is, the corresponding surface has a metallic brilliancy, a quasi-mirror-like appearance. Sections of the surface are then covered. This covering is implemented using at least one template that has openings, wherein the brilliant surface of the roof rack is not covered in the region of the openings, and/or the template does not cover certain areas of the brilliant-finish surface of the roof rack. Subsequently, an abrasion treatment is implemented such that the polished surface of the roof rack is abraded to achieve a satin-finish surface within the openings and/or in the regions not covered. In particular, blast-cleaning, etching, and/or brushing can be implemented as the abrasion treatment. The template is then removed, and what results is a completely new, striking appearance. The surface thus achieved obtains a special visual effect due to the polished areas that are not completely destroyed but are abraded areas such that they appear with satin finish in combination with the still-brilliant-finish areas, which effect manifests itself in a high brilliancy and three-dimensional effect. This procedure can also be used to generate not only random zones, but to produce also inscriptions, patterns, etc.

What becomes evident from the above description is that the invention entails the use of two surface treatments in a multistage operation process, whereby that the entire surface is first given a brilliant finish and then abraded in certain areas. The surface areas containing the brilliant finish border on the satin-finish areas, in other words, the not-completely-destroyed but previously polished areas, and generate a special visual effect. In this way, the covering technique, in particular, the template technique, can be used to apply characters, logos, pictograms, numbers, etc., where, for example, the numbers can appear brilliant on a satin-finish background, or visa versa, that is, the numbers have a satin finish on a brilliant-finish surface. It is of course understood that this type of texturing is not limited to the creation of numbers; instead, any desired brilliant/satin-finish textures can be generated. Identification marking can also be implemented based on the surface textures thus formed, such as, for example, anti-theft marking, batch tracing, coding, or the like; or the procedure according to the invention is implemented purely for visual design-related reasons. The invention relates in particular to roof moldings composed of aluminum or aluminum alloy, having a surface that at least in certain areas is polished to a brilliant finish and has a satin finish at least as a result of abrasion implemented in certain areas after the polishing.

After the brilliant-finish and satin-finish areas are completed, the entire surface thus textured is anodized. It is also possible to omit the anodizing step.

1-8. (canceled)

9. A method for the surface treatment of a roof rack for a motor vehicle, the roof rack being constructed of aluminum and/or aluminum alloy, the method comprising:
polishing at least a portion of the surface to achieve a polished surface having brilliant finish; and
subsequently abrading at least a portion of the polished surface to achieve a satin-finish surface section.

10. The method according to claim 9, wherein abrading is implemented only on a spot basis.

11. The method according to claim 9, wherein abrading includes blast-cleaning.

12. The method according to claim 9, wherein abrading includes etching.

13. The method according to claim 9, wherein abrading includes brushing.

14. The method according to claim 10, further comprising using at least one cover to retain at least one brilliant-finished section and create at least one satin-finished section that is abraded during the abrading due to the lack of a cover.

15. The method according to claim 14, wherein the cover is a template.

16. The method according to claim 14, further comprising anodizing the at least one brilliant-finished section.

17. The method according to claim 14, further comprising anodizing the at least one satin-finished section.

18. The method according to claim 14, further comprising anodizing the at least one brilliant-finished section and the at least one satin-finished section.

19. A roof rack constructed of aluminum or aluminum alloy, the roof rack having a surface with at least a first portion having a brilliant finish as the result of polishing, and at least a second portion having a satin-finish due to abrasion implemented after polishing.
